(19) United States
(12) Patent Application Publication
(10) Pub. No.: US 2014/0117061 A1
(43) Pub. Date: May 1, 2014

(54) ELECTRONIC TABLET HOLDER

(71) Applicant: Bahman Hadi, Redmond, WA (US)

(72) Inventor: Bahman Hadi, Redmond, WA (US)

(21) Appl. No.: 13/663,842

(22) Filed: Oct. 30, 2012

(51) Int. Cl. B60R 11/02

(52) U.S. Cl. 224/282

(57) ABSTRACT

A portable support for an electronic tablet, including a first and section to display and capture the tablet and a second section, hinged to the first section, adapted to be removable secured to a tray table. The electronic tablet holder may be carried inside a vehicle on person, or it can be offered to the passenger by the operators of the vehicle along with a tablet for a fee.

### TECHNICAL FIELD

This invention relates to the support, storage and carrying of electronic equipment, and more particularly to an electronic tablet holder which protects, displays and adapts an electronic tablet for use in conjunction with a tray table or the like.

### BACKGROUND OF THE INVENTION

As travel has evolved, whether it be automobile, bus, train or airplane, there has been more emphasis placed on convenient accommodation and/or entertainment for the passenger. Traditionally, trains and airplanes have provided tray tables for use during travel. Airlines, because of the typical length of the journey, have provided in-flight entertainment which has evolved from central aisle-located screens to individual screens. It is recognized that the provision for entertainment of the passenger is both expensive and heavy. Therefore, it is perceived, since more and more people carry electronic tablets, that to provide a device which not only enables but encourages the use of personal electronic tablets on the airplane would reduce the duties of the flight attendant as well as reduce the weight of the airplane itself and save an airline enormous amounts of IFE repair cost.

Prior art known to the present inventor includes:

U.S. Pat. No. 6,663,072 to Ritchey et al, which discloses a stabilizing device for supporting a laptop computer on the lap of the user and further includes a lid, thereby providing a storage capacity for the computer;

U.S. Patent Publication No. US2005/0077448 to Rossini, which discloses a laptop computer stand which includes a base which is adapted to either sit on a surface or to be coupled to a structure.

U.S. Patent Publication No. 2001/0003961 to Hodge et al discloses a laptop computer workstation which includes a wire frame attached to a wooden plate and then to be secured to a tray table or the like.

U.S. Patent Publication No. 2011/0203955 to Fasula discloses a multipurpose iPAD case which when opened has a sun/privacy shade and a rigid pocket for the device to lean on, including adjustable angularity.

U.S. Patent Publication No. US2012/0063066 to Floit discloses an ergonomic accessory for use with an electronic device, wherein the device becomes ergonomically attached to the hand or wrist of the user

### DISCLOSURE OF THE INVENTION

With the above-noted prior art in mind, the goal of the present invention is to provide a holder, which could be provided by the tablet owner or the airline, bus line or rail line, enabling a passenger to support and comfortably use an electronic tablet during the commute.

It is a goal to provide such an electronic device holder that is inexpensive, durable, lightweight, easy to store or stow away, and easy to secure to an electronic tablet and to a tray table or the like. There is provided a sleeve to receive the electronic tablet while leaving the face of the tablet exposed. The sleeve is configured and shaped of such a material that the tablet can easily slip into the sleeve, secure while in the sleeve, and likewise easily removed. The holder itself can easily be stored away while not in use.

The inventive sleeve which secures the tablet is secured to a base member which is lightweight, durable and easily slips over the tray table, securing the tablet in place on the tray table. It should be understood that the connection between the base member and the sleeve member is adjustable to allow various viewing angles. In terms of use in airplanes, the holder in its current concept will not require any certification of any kind; it can simply be carried on board in person by a passenger.

### BRIEF DESCRIPTION OF THE DRAWINGS

FIG. 1 shows the inventive holder with an electronic tablet adjacent thereto.

FIG. 2 shows the inventive electronic tablet holder with the tablet partially inserted therein.

FIG. 3 shows the inventive electronic tablet holder with the tablet fully inserted.

FIG. 4 shows the tablet in the holder prior to placement on a tray table.

FIG. 5 shows the tablet in the holder partially secured to the tray table.

FIG. 6 shows the tablet in the holder fully secured to the tray table.

### BEST MODE FOR CARRYING OUT THE INVENTION

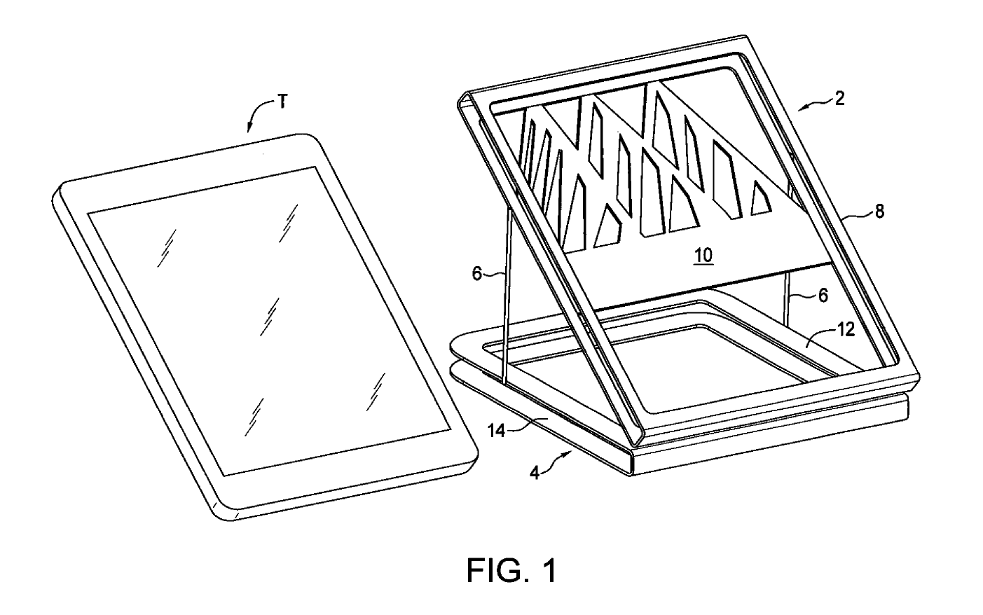

As seen in FIG. 1, the electronic tablet T is to be placed into a tablet holder which includes a front panel 2, a base panel 4 and an adjustable support 6. When mass-produced, the electronic tablet holder will be able to accommodate various sizes of current or future tablets available in the market. The front or face panel 2 includes an outwardly facing rectangular frame element 8 which encompasses the tablet yet leaves the screen exposed for use, and a back portion 10 spaced from the frame-like element 8 such that the tablet can be slipped in between. It is to be understood that the front portion 2 is made of a rigid, flexible, durable material such that it not only supports in a utilitarian fashion but also secures the tablet in place. Foam-type materials compatible with the innovation may be used to completely secure various tablet sizes in place. The support element 4 includes a top rectangular-shaped element 12 and a spaced bottom element 14 so that the entire tablet holder with a tablet in place, as explained hereinafter, can be slipped over a tray table and held securely in position.

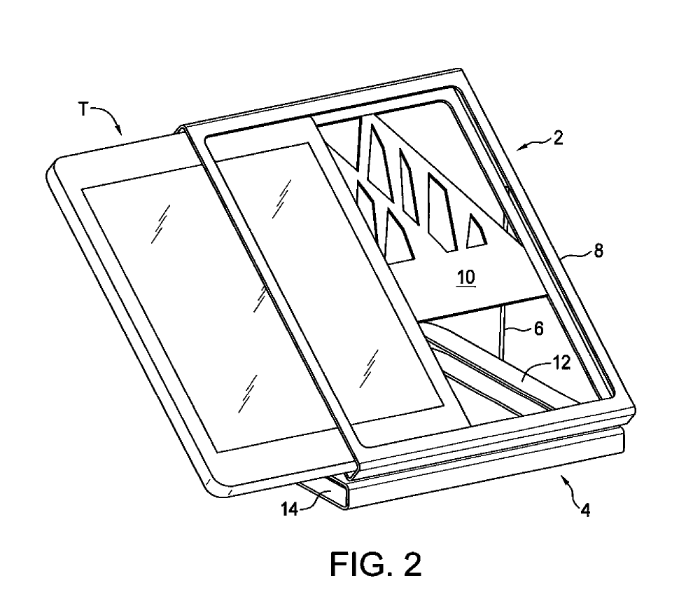

Reference is had to FIG. 2, wherein the tablet is partially inserted into the holder.

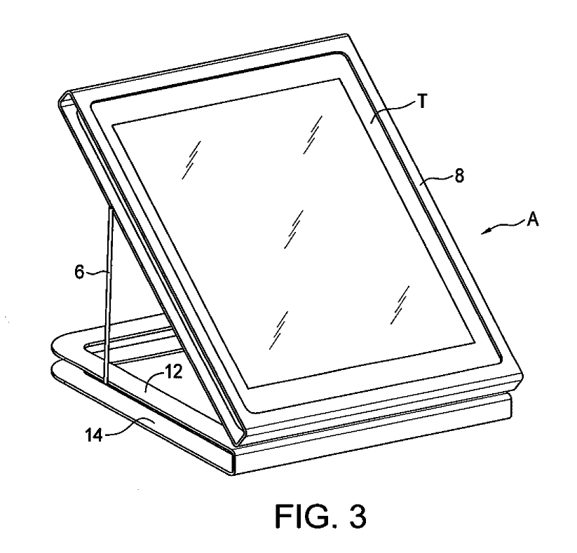

Reference is now had to FIG. 3, wherein the tablet is fully inserted into the holder. The unit as seen in FIG. 3 will be now be denoted as assembly A for the remaining figures.

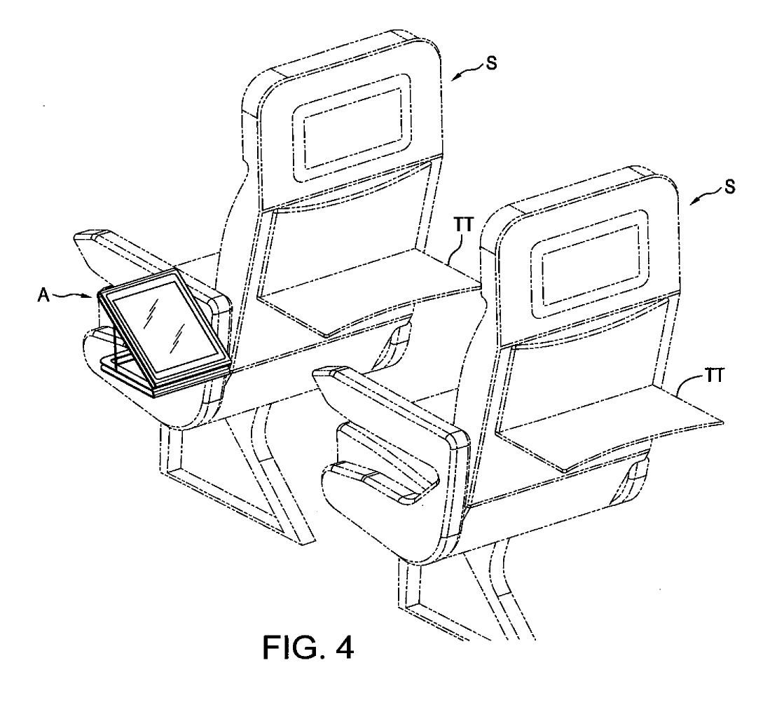

As seen in FIG. 4, as shown for illustrative purposes only, are two airplane seat rows having tray tables TT. As can be seen, the assembly A is positioned to be placed upon the tray table TT.

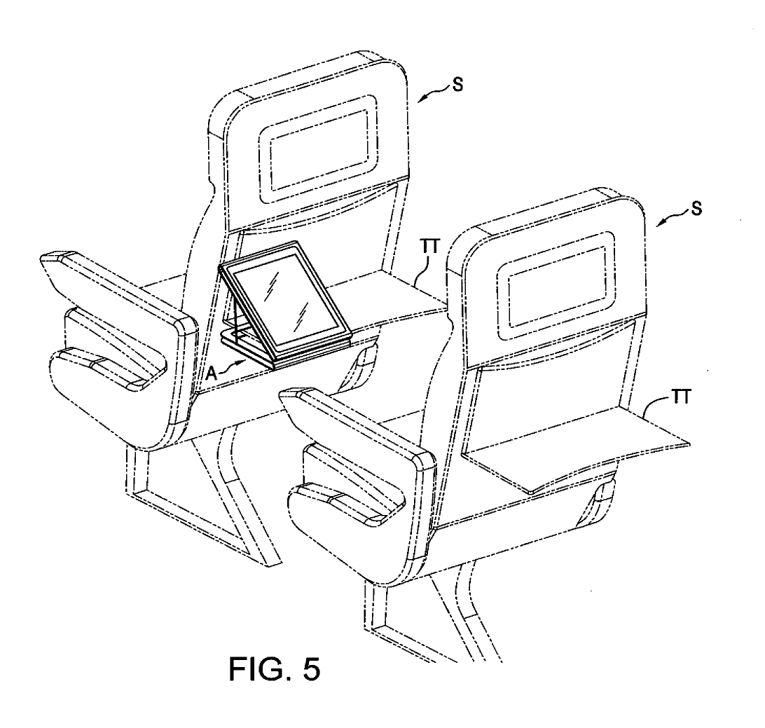

Referring now to FIG. 5, assembly A has been partially slipped over the side of tray table TT.

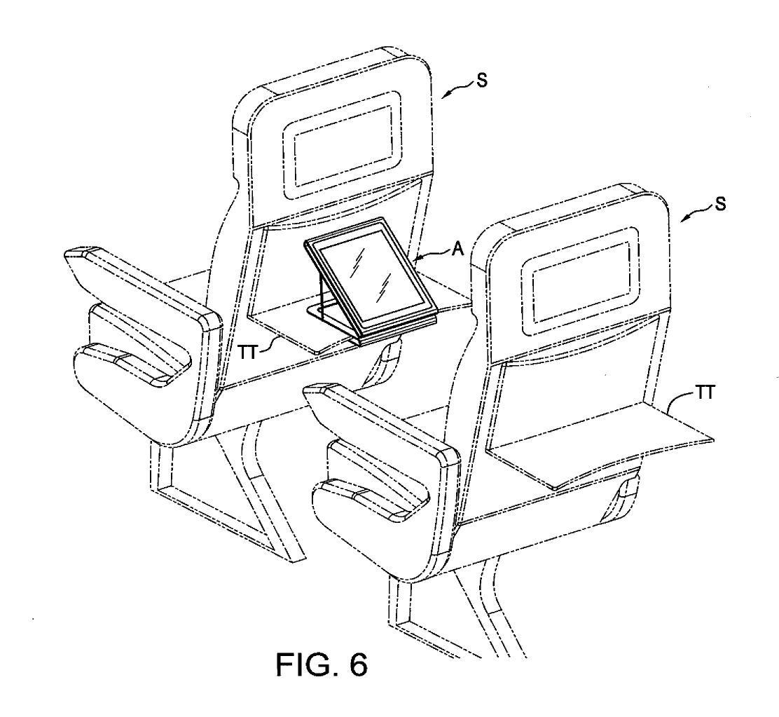

As best seen in FIG. 6, the assembly A has been fully inserted over the tray table TT and is in position for use. Foam-type materials compatible with the innovation may be used to completely secure the assembly A in place.

As can be seen, the present invention provides a simple, lightweight, durable, inexpensive means of adapting an electronic tablet for use in a vehicle utilizing a tray table.

Although a preferred embodiment of the invention has been disclosed for purposes of illustration, it should be understood that various changes, modifications and substitutions may be incorporated in the embodiment without departing from the spirit of the invention, which is defined by the claims which follow.

What is claimed is:

1. An electronic tablet holder for use in a vehicle, comprising:
a first section designed to removably and securely hold and support an electronic tablet; and
a second section hingedly secured to the first section, designed to be fixedly yet removably secured to a relatively fixed object, such as a tray table.

2. An electronic tablet holder as in claim 1, wherein the first section includes a front element to surround and yet display the screen of the tablet, and a back element spaced from the front element to allow the tablet to be inserted between the front and back elements and resist prevent inadvertent removal thereof.

3. An electronic tablet holder as in claim 1, wherein the second section is adapted to slip over and encompass a tray table.

4. An electronic tablet holder as in claim 1, wherein the first and second sections may be secured at select angles for convenient use.
